(19) United States
(12) Patent Application Publication
(10) Pub. No.: US 2019/0044950 A1
(43) Pub. Date: Feb. 7, 2019

(54) Detection of Compromised Access Points

(71) Applicant: QUALCOMM Incorporated, San Diego, CA (US)

(72) Inventors: Yin CHEN, Campbell, CA (US); Seyed Ali AHMADZADEH, San Jose, CA (US); Saumitra Mohan DAS, San Jose, CA (US)

(21) Appl. No.: 15/667,412

(22) Filed: Aug. 2, 2017

(51) Int. Cl. H04L 29/06

(52) U.S. Cl. CPC H04L 63/107; H04W 12/08; H04L 63/1441; H04L 63/1416

(57) ABSTRACT

Various embodiments include systems and methods of determining whether a compromised access point is present in a communication network. A processor of a wireless communication device may predict one or more websites that the wireless communication device will access during a future session with the one or more websites. The processor may establish a secure connection with the communication network, request a digital certificate for one or more of the predicted websites, and store a digital certificate received from each of the predicted websites. The processor may determine whether a compromised access point is present in the communication network by comparing one of the digital certificates from the predicted websites with a digital certificate received from a website server during a current session.

### BACKGROUND

A compromised or rogue access point may gain unauthorized access to a wireless network which may create a security risk in a communication network. For example, a rogue access point may initiate a man-in-the-middle (MITM) attack. MITM attacks have become a particular threat in wireless communication networks due to the ease of setting up a rogue device (e.g., base station or Wi-Fi access point) within an area served by a legitimate (i.e., benign) base station or Wi-Fi access device. For example, a MITM attack can occur when a wireless communication device (e.g., a laptop computer, pad or smartphone) attempts to establish a wireless communication link with a legitimate base station or Wi-Fi access point but instead establishes a wireless communication link with a rogue device. In such a situation, the rogue device intercepts communications between the wireless communication device and a communication network (e.g., the Internet). While appearing to act as a legitimate wireless access point, the rogue device may monitor (e.g., to steal passwords, etc.) or alter the intercepted communications. In addition to compromising personal and security information, a MITM attack by a rogue device can lead to attacks on websites accessed by the wireless communication device and on network devices accessed from applications executed on the wireless communication device.

### SUMMARY

Various embodiments include methods that may be implemented in a processor of a computing device for determining whether a compromised access point is present in a first communication network. Various embodiments may include determining whether digital certificate information received from a website server during a current session matches digital certificate information for the website server obtained via a second communication network different from the first communication network, and determining that a compromised access point is present in the first communication network in response to determining that the digital certificate information received from the website server during the current session does not match the digital certificate information for the website server obtained via the second communication network.

Some embodiments may further include accessing the website server via the second communication network, wherein the second communication network is a trusted network, obtaining the digital certificate information from the website server via the second communication network, and storing the digital certificate information for the website server in memory of the first communication network. In some embodiments, determining whether digital certificate information received from the website server during a current session matches digital certificate information obtained for the website server via a second communication network may include determining whether the digital certificate information received from the website server during the current session matches the digital certificate information for the website server stored in memory of the first wireless communication device.

Some embodiments may further include transmitting a request for digital certificate information for the website server from a second wireless communication device distant from the first wireless communication device, and receiving digital certificate information for the website server from the second wireless communication device. In some embodiments, determining whether digital certificate information received from the website server during the current session matches digital certificate information obtained for the website server via the second communication network may include determining whether the digital certificate information received from the website server during the current session matches the digital certificate information for the website server received from the second wireless communication device.

In some embodiments, determining whether digital certificate information received from the website server during the current session matches digital certificate information obtained for the website server via the second communication network may include transmitting the digital certificate information received from the website server during the current session to a server, and receiving an indication from the server regarding whether the transmitted digital certificate information received from the website server during the current session matches valid digital certificate information for the website server.

Some embodiments may further include predicting websites that the first wireless communication device may access during a future session, establishing a communication link with a trusted second communication network, accessing website servers associated with each of the websites that the first wireless communication device may access during a future session, obtaining digital certificate information from each accessed website server via the second communication network, and storing in memory of the first communication network the digital certificate information obtained from each accessed website server. In some embodiments, determining whether digital certificate information received from a website server during a current session matches digital certificate information obtained for the website server via a second communication network may include determining whether the digital certificate information received from the website server during the current session matches digital certificate information for the website server stored in memory of the first wireless communication device. In some embodiments, predicting websites that the first wireless communication device may access during a future session may include extracting from memory information regarding previously accessed website domains at least one of a website domain and a website URL, and predicting one or more websites that the processor first wireless communication device will access during a future session with the one or more websites based on the extracted information regarding previously accessed website domains the at least one of the website domain and the website URL. In some embodiments, extracting from memory information regarding previously accessed website domains the at least one of the website domain and the website URL may include at least one of unpacking binaries received by of one or more applications during previous website sessions, extracting information from source code of the one or more applications, extracting information from one or more libraries that are used by the one or more applications, extracting information from metadata of the one or more applications, extracting information from a description of the one or more applications, extracting information from a previous version of the one or more applications, and extracting information from bytecode associated with the one or more applications.

Various embodiments may include methods implemented by a server determining whether a compromised access point is present in a communication network, such as detecting whether a man in the middle (MITM) attack is underway or threatened. Various embodiments may include receiving digital certificate information received by the wireless communication device for a website server during a current session, comparing the digital certificate information received from the wireless communication device to digital certificate information associated with the website stored in memory of the server that was previously received from wireless communication devices, and transmitting an indication regarding whether the digital certificate information received from the wireless communication device matches valid digital certificate information for the website server stored in memory of the server.

Some embodiments may further include determining a probability that the digital certificate received from the wireless communication device was transmitted via a benign access point based on comparing the digital certificate received from the wireless communication device to digital certificate information associated with the website stored in memory of the server that was previously received from wireless communication devices, and determining whether the determined probability that the digital certificate received from the wireless communication device was transmitted via a benign access point is within a threshold. In some embodiments, transmitting the indication regarding whether the digital certificate information received from the wireless communication device matches valid digital certificate information for the website server stored in memory of the server may include transmitting the indication that the digital certificate received by the wireless communication device was received via a rogue access point in response to determining that the calculated probability that the digital certificate received by the wireless communication device was transmitted via a benign access point is not within the threshold.

Some embodiments may further include determining a location of the wireless communication device, determining locations of wireless communication devices associated with the previously received digital certificate information, and selecting for comparison digital certificate information associated with the website stored in memory of the server that was previously received from wireless communication devices located a threshold distant from the wireless communication device. In some embodiments, comparing the digital certificate information received from the wireless communication device to digital certificate information associated with the website stored in memory of the server that was previously received from wireless communication devices may include comparing the digital certificate information received from the wireless communication device to the selected digital certificate information.

Various embodiments may further include a wireless communication device having a communication interface capable of communicating with a first communication network or a second communication network, a memory, and a processor configured with processor executable instructions to perform operations of the methods summarized above. Various embodiments include a server having a communication interface configured to communicate with the communication network, a memory, and a processor configured with processor executable instructions to perform operations of the methods summarized above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the various embodiments.

FIG. 1 is a component block diagram of a communication system suitable for use with various embodiments.

FIG. 2 is a process flow diagram illustrating a method of retrieving digital certificates for predicted websites according to various embodiments.

FIG. 3 is a process flow diagram illustrating a method of determining whether a compromised access point is present in a network according to various embodiments.

FIG. 4 is a process flow diagram illustrating another method of determining whether a compromised access point is present in a network according to various embodiments.

FIG. 5 is a process flow diagram illustrating a method of determining a probability of whether a digital certificate is transmitted via a benign access point according to various embodiments.

FIG. 6 is a process flow diagram illustrating another method of determining a probability of whether a digital certificate is transmitted via a benign access point according to various embodiments.

FIG. 7 is a process flow diagram illustrating another method of determining whether a compromised access point is present in a network according to various embodiments.

FIG. 8 is a component block diagram of a wireless communication device according to various embodiments.

FIG. 9 is a component block diagram of a server device according to various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and embodiments are for illustrative purposes, and are not intended to limit the scope of the various embodiments or the claims.

Various embodiments include methods, and computing devices configured to implement the methods, for detecting a threat or occurrence of a compromised access point in a wireless communication network, such as detecting whether a man in the middle (MITM) attack is underway or threatened. In various embodiments, a processor of a wireless communication device or a processor of a shared server may determine an occurrence of a compromised access point based on comparisons of a digital certificate received from a website with a digital certificate for the website received via a secure link, either earlier while accessing the website via a secure network or via another communication link that cannot be vulnerable to the same compromised access point.

The term “wireless communication device” is used herein to refer to any device that may use radio frequency (RF) communications to communicate with another device, for example, as a participant in a wireless communication network. A wireless communication device implementing various embodiments may include any one or all of mobile computing devices, laptop computers, tablet computers, cellular telephones, smartphones, personal or mobile multi-media players, personal data assistants (PDAs), smartbooks, palmtop computers, wireless electronic mail receivers, multimedia Internet enabled cellular telephones, wireless gaming systems and controllers, smart appliances including televisions, set top boxes, kitchen appliances, lights and lighting systems, smart electricity meters, air conditioning/HVAC systems, thermostats, building security systems including door and window locks, vehicular entertainment systems, vehicular diagnostic and monitoring systems, unmanned and/or semi-autonomous aerial vehicles, automobiles, sensors, machine-to-machine devices, and similar devices that include a programmable processor, memory, and/or circuitry for establishing wireless communication pathways and transmitting/receiving data via wireless communication networks. Various embodiments may be particularly useful in mobile computing and mobile communication devices, such as smart phones, tablet computers and other portable computing platforms that are easily transported to locations where rogue access points may lurk.

The term “rogue access point” is used herein to refer to any access point that is not authenticated or authorized to communicate in a wireless communication network. A rogue access point may transmit forged communications such as a fraudulent digital certificate. A rogue access point may be any type of wireless network access point including a rogue base station or rogue Wi-Fi access point.

The terms “component,” “module,” “system,” and the like as used herein are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a communication device and the communication device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

A digital certificate may be electronic document used to prove ownership and/or to certify the trustworthiness of the entity transmitting the digital certificate. The digital certificate may include information about the identity of the owner (or subject) of the digital certificate and a digital signature of a Certificate Authority (CA) (or issuer of the digital certificate) that has verified the contents of the digital certificate. In some embodiments, the digital certificate may further include a key pair (e.g., a public key and a private key) used to encrypt and decrypt information communicated between the owner or subject of the digital certificate and a receiving device.

A website server may transmit the digital certificate associated with the website during a communication session in response to a wireless communication device establishing a connection with the website server in order to certify that the website server is trustworthy. However, when a compromised access point (e.g., a rogue access point) is present in the network path (e.g., a specific client-server flow) between the wireless communication device and the website server, the rogue access point may initiate attacks on a website accessed by a user's wireless communication device (when the website is not protected by pinning), on a network associated with the website accessed by the user's wireless communication device using applications stored on the wireless communication device, and/or on the wireless communication device. In some situations, a rogue access point may establish wireless communication devices and perform in a normal manner for some time before taking a nefarious or non-benign action. Thus, a rogue access point may pose a threat of a MITM attack before initiating an attack. For ease of reference, the term “MITM attack” may be used herein to encompass both an ongoing MITM attack and the threat that an MITM attack could be initiated via an established wireless communication link with a compromised access point.

In some MITM attacks, a rogue access point may intercept a genuine digital certificate and replace the genuine digital certificate with a fraudulent digital certificate which may allow the rogue access point to undesirably affect the performance of the wireless communication device and/or to gain unauthorized access to the wireless communication device, the website server, and/or the wireless communication network as well as information communicated between the wireless communication device and the website server over the wireless communication network.

The detection of a MITM threat or attack initiated by a rogue or compromised access point using a digital certificate poses challenges in conventional communication systems. This is particularly the case for a mobile wireless communication device that may access wireless networks in public locations and receive a digital certificate for a website during a current session with no prior knowledge of the authenticity of the digital certificate.

Various embodiments include methods that may be implemented on a wireless communication device and/or on a shared server for determining whether the wireless communication device is threatened by or experiencing a security attack (e.g., a MITM attack) initiated by a compromised access point during a current session with a website. In various embodiments, the processor of a wireless communication device and/or the processor of a shared server may determine whether a compromised access point is in communication with the wireless communication device during a current session with a website based on website digital certificate information acquired outside of the current session with the website.

In some embodiments, a wireless communication device may use a secure or trusted wireless communication network to acquire and store a certificate of a domain that the wireless communication device is expected to communicate with using an application executed by the wireless communication device. In such embodiments, a processor of the wireless communication device may unpack binaries and extract domains to detect or identify a website and/or URLs that may be accessed by the wireless communication device in the future. The wireless communication device may identify one or more websites and/or URLs that the wireless communication device may access in the future in various ways. For example, the wireless communication device may extract the information associated with the one or more websites and/or URLs from source code, unpacked binaries, libraries that may be used by one or more applications, from application metadata and/or description, previous versions of the application, bytecode, etc.

The wireless communication device may use this information to create a predicted list of potential websites and/or URLs that one or more applications of the wireless communication device may try to access. The one or more applications may not need to be executed in order to extract the information to identify the one or more websites and/or URLs that the wireless communication device may access in the future. The information to identify the one or more websites and/or URLs that the wireless communication device may access in the future may be collected at the time each application is installed or at a later time by running a specific process designated to de-compile or extract source information from binaries. For example, the wireless communication device may run a SPHINX/SPA process in order to extract the information used to identify the one or more websites and/or URLs that the wireless communication device may access in the future.

The process of identifying one or more websites and/or URLs the wireless communication device may access in the future may be performed whether or not the wireless communication device has accessed the one or more websites and/or URLs in the past. While the one or more websites and/or URLs may have been accessed in previous sessions, there is no need for the website, URL, and/or application to have been previously accessed or executed by the wireless communication device in order to identify or predict the one or more websites and/or URLs the wireless communication device may access in the future.

Then when the wireless communication device has a connection to a trusted or secure communication network (e.g., the user's home network), the wireless communication device may request and/or obtain the digital certificates associated with each extracted domain via a trusted processor or a trusted interface (as annotated by QSSP), and store a certificate signature in memory (e.g., a secure memory). Later, when the wireless communication device uses an untrusted (e.g., public) wireless communication network to establish a session (the “current session”) with a website domain, a processor of the wireless communication device may compare the stored certificate signature with a certificate signature of a digital certificate for the domain extracted from the unpacked binaries received during the current session. In response to determining that the certificate signatures are different, the wireless communication device processor may determine that an MITM attack is threatened or occurring during the current session with the domain. In response to determining that the certificate signatures are the same, the wireless communication device processor may determine that there is little or no threat of an MITM attack during the current session with the domain.

In some embodiments, a first wireless communication device may establish a connection with a website or a domain and receive a digital certificate during a current session, and transmit a request for the website's digital certificate to a shared server that may in communication with a second wireless communication device that has established a connection the same website or domain. In response to the request, the second wireless communication device may transmit to the first wireless communication device (directly or via the server) the digital certificate that the second wireless communication device received from the same website or domain via a different communication network. For example, the different communication network may be another wireless communication network far enough removed from the first wireless communication device that the same rogue access point could not be communicating with both the first and second wireless communication devices (e.g., beyond the maximum range of WiFi access points). The first wireless communication device may compare the certificate signature of the digital certificate that was received directly by the first wireless communication device with the certificate signature of the digital certificate received from the second wireless communication device. In response to determining that the certificate signatures are different, the wireless communication device processor may determine that a compromised access point is in communication with the wireless communication device during the current session. In response to determining that the certificate signatures are the same, the wireless communication device processor may determine that an MITM attack is not threatened or occurring during the current session. Such embodiments enable wireless communication devices to determine whether an MITM is threatened or occurring using crowdsourcing leveraging information obtained by wireless communication devices that could not be subject to the same rogue access point.

In some embodiments, the comparison of the current digital certificate with a digital certificate acquired outside of the current session with the website may be performed by a secure processor included in a secure area/trust zone of the wireless communication device.

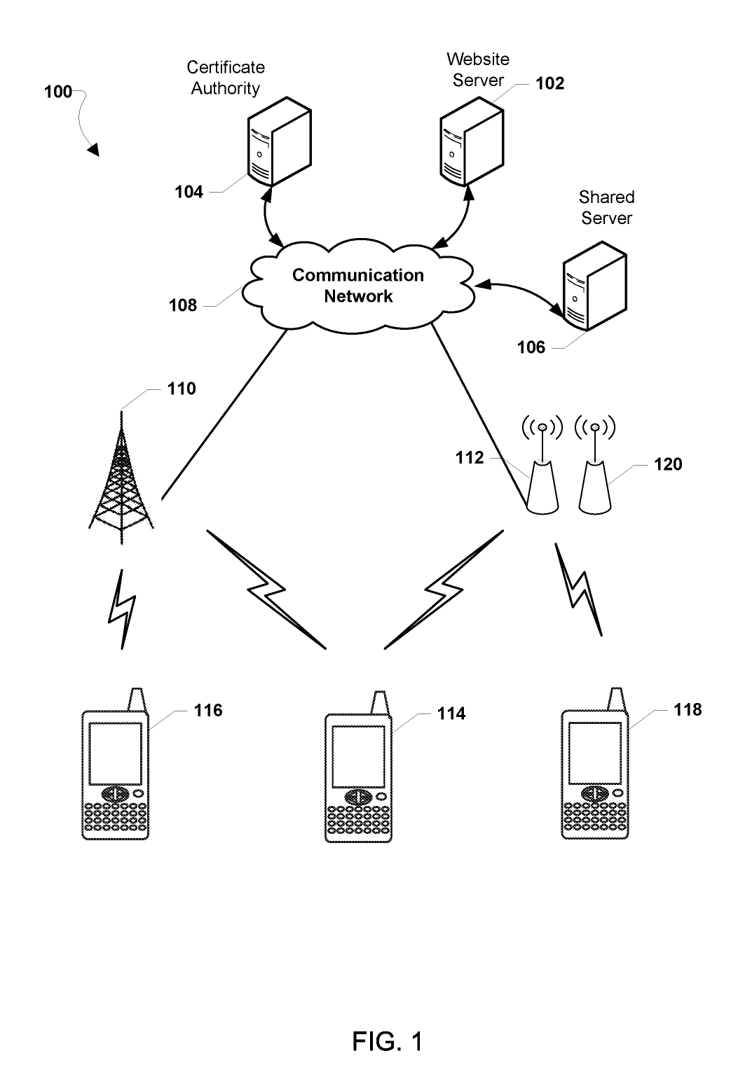

Various embodiments may be implemented within a variety of communication systems 100, an example of which is illustrated in FIG. 1. The communication system 100 may include a website server 102, a Certificate Authority (CA) 104, a communication network 108, a first access point 110, a second access point 112, a third access point 120, and one or more wireless communication devices such as wireless communication devices 114, 116, and 118. In some embodiments, the communication system 100 may further include a shared server 106.

The website server 102 may be a server configured to host a website. A website is a set of related webpages typically served from a single Web domain. In some embodiments, the one or more wireless communication devices 114, 116, and 118 may retrieve, present, and/or traverse information resources provided by the website server 102 (e.g., a web server on the World Wide Web). An information resource may be identified by a uniform resource identifier (URI) and may be a webpage, image, video, client-side scripts, and/or another piece of content.

The CA 104 is an entity that may issue digital certificates. The CA 104 may also digitally sign the digital certificate to certify the trustworthiness of the entity transmitting the digital certificate.

The shared server 106 may be a third party validation entity. In some embodiments, the shared server 106 may be configured to receive, store, and/or analyze a digital certificate received from one or more wireless communication devices over the communication network 108. The shared server 106 may receive the digital certificate from one or more of the wireless communication devices 114, 116, 118 and/or other wireless communication devices in communication with the communication network 108.

The first access point 110, the second access point 112, and/or the third access point 120 may be configured to communicate with one or more the wireless communication devices 114, 116, 118. While FIG. 1 may illustrate that the first access point 110 is a base station (e.g., macrocell access point) and the second access point 112 and the third access point 120 are Wi-Fi access points, the first access point 110, the second access point 112, and/or the third access point 120 may be any type of wireless access point. For example, the first access point 110, the second access point 112, and/or the third access point 120 may be a cellular base station, a macrocell access point, a Wi-Fi access point, a microcell access point, a picocell access point, a femtocell access point, or the like.

While three access points are illustrated in FIG. 1, any number of access points may be implemented within the communication system 100. For example, the communication system 100 not include the third (i.e., rogue) access point 120 when a compromised access point is absent from the communication system 100. In addition, while it is likely that at least one of the first access point 110, the second access point 112, and/or the third access point 120 is a Wi-Fi access point, the communication system 100 does not require a Wi-Fi access point to implement any of the various embodiments.

The first access point 110 and the second access point 112 may be benign access points authorized by the communication system 100 in which the first access point 110 and the second access point 112 may be in communication with the communication network 108. The first access point 110 and/or the second access point 112 may be configured to communicate with the communication network 108 over a wired or wireless communication link, which may include twisted-pair backhaul links, fiber optic backhaul links, microwave backhaul links, cellular data networks, and other suitable communication links. The second access point 112 may be a wireless local area network (WLAN) access point, such as a Wi-Fi “hotspot.”

For purposes of example, the third access point 120 is a rogue access point or a compromised access point configured to impersonate a benign or authorized access point. For example, the third access point 120 is a rogue access point that may forge communications between the communication network 108 and the one or more wireless communication devices 114, 116, 118. The rogue access point may generate a fraudulent digital certificate to communicate to the one or more wireless communication devices 114, 116, 118 during a current session with a website server. In some situations, the third access point 120 may be a stand-alone device or the third access point 120 may be integrated into another device. For example, someone intent on executing a MITM attack in a public wireless network may use a laptop computer configured to broadcast its availability as a wireless, establish wireless communication links with any devices (e.g., 114, 118) responding to the broadcasts, and then relay communications between the connected devices and webservers 102 via its own link to the Internet while monitoring and/or modifying the communications.

The rogue access point may gain access to the communication network 108 using various techniques. For example, the rogue access point may forge or spoof a media access control (MAC) address of a benign access point 110 or 112. In some situations, the third access point 120 may also have gained unauthorized access to communicate with the communication network 108 or separately with the Internet so as to support wide area network communications to appear legitimate while otherwise conducting a cyber-attack.

The first access point 110, the second access point 112, and/or the third access point 120 may establish communication links including one or more of a plurality of carrier signals, frequencies, or frequency bands, each of which may include a plurality of logical channels. The first access point 110, the second access point 112, and/or the third access point 120 may establish communication links using a relatively short-range wireless communication protocol such as Wi-Fi, ZigBee, Bluetooth, IEEE 802.11, and others. Alternatively, the first access point 110, the second access point 112, and/or the third access point 120 may establish communication links using cellular communication links using 3GPP Long Term Evolution (LTE), Global System for Mobility (GSM), Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies. Additionally, the first access point 110, the second access point 112, and/or the third access point 120 may establish communication links using more than one radio access technology (RAT).

The one or more wireless devices 114, 116, 118 may be in communication with one or more of the first access node 110, the second access node 112, and/or the third access node 120. In some situations, as illustrated in FIG. 1, the wireless device 114 may be in communication with the first access node 110 and the second access node 112 when the second access node 112 is a benign access node and/or the third access node 120 when the third access node 120 is a rogue access node. However, each of the wireless devices 114, 116, and 118 may establish communication with one or more access nodes including the first access node 110, the second access node 112, and the third access node 120. In addition, while only three access nodes (e.g., 110, 112, 120) and three wireless communication devices (e.g., 114, 116, 118) are illustrated in FIG. 1, system 100 may include any number of access nodes and any number of wireless communication devices.

In various embodiments, the one or more wireless communication devices 114, 116, 118 may determine whether a compromised access point is detected during a current session with a website based on digital certificate information associated with the website acquired outside the current session with the website. In some embodiments, a wireless communication device 114 may predict or anticipate websites that the wireless communication device 114 will access in the future and preemptively request and store digital certificates for each predicted website while connected to a secure or trusted network. After the wireless communication device 114 accesses a wireless network (e.g., a public WiFi network), accesses a website using an application installed on the wireless communication device 114 and receives a digital certificate during a current session with the website, a processor of the wireless communication device 114 may compare the previously stored digital certificate with the digital certificate received during the current session to determine whether the wireless communication device 114 is currently experiencing an MITM attack by a compromised access point.

In some embodiments, a first wireless communication device 114 and/or the shared server 106 may determine whether the first wireless communication device 114 is currently experiencing an MITM attack by crowdsourcing information received from one or more other wireless communication devices 116, 118. In some embodiments, the shared server 106 may calculate a probability that a digital certificate is transmitted via a benign access point based on a plurality of digital certificates received from a plurality of different wireless communication devices that established communication with the website. In some embodiments, the first wireless communication device 114 may contact the shared server 106 or a second wireless communication device 116 and/or a third wireless communication device 118 to compare digital certificates where the second wireless communication device 116 and the third wireless communication device 118 established a connection with the website from a different geographic location from the geographic location of the first wireless communication device 114.

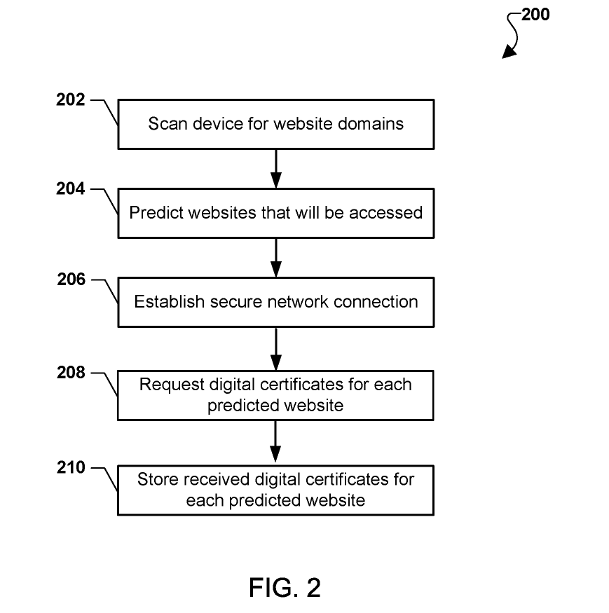

FIG. 2 is a process flow diagram illustrating a method 200 of retrieving and store digital certificates for predicted websites according to various embodiments. With reference to FIGS. 1 and 2, the method 200 may be implemented by one or more processors of a wireless communication device (e.g., 114, 116, 118).

In block 202, a processor of a wireless communication device may scan the wireless device for website domains. For example, the processor may scan one or more applications stored on the wireless communication device (including a browsing history of the wireless communication device), one or more caches, and/or memory of the wireless communication device to determine websites that the wireless communication device may access in the future. In some embodiments, the wireless device may run software to unpack binaries and extract website domains.

In block 204, the processor may predict websites that are likely to be accessed. For example, the processor may predict websites that the wireless communication device is likely to access in the future. The prediction of the websites that the wireless communication device may access may be based on one or more factors including, for example, whether the wireless communication device has ever accessed the website, how many times the wireless communication has accessed the website, how frequently the website has been accessed within a predetermined time period, whether an application is mapped to the website, how often the website is accessed via various applications installed on the wireless communication device, how often an application that accesses or is linked to the website is executed, etc.

In block 206, the processor may establish a secure network connection. In some embodiments, the processor may establish a connection with a communication network using a known or trusted access point. The processor may determine that an access point is a known or trusted access point in various ways. For example, if the wireless communication device has access to one or more access points that are known to be benign access point (e.g., an access point of a known private network, the user's home network, etc.), the processor may initiate establishing a network connection via the known or trusted access point.

In block 208, the processor may request a digital certificate for each predicted website. For example, for each of the predicted websites, the processor may request a digital certificate from each website over the network connection established via the known/trusted access point. Requesting (and receiving) a digital certificate from each website over the network connection established via the known/trusted access point (e.g., an assumed uncompromised path) may reduce the likelihood that the digital certificate is a fraudulent certificate transmitted via a rogue access point. In some embodiments, the processor may request a digital certificate for every predicted website while connected to the trusted network. Alternatively, the processor may rank and/or weight the likelihood that the wireless communication device will access a website and send a request for a digital certificate for each predicted website that exceeds a predetermined rank and/or weight threshold.

In some embodiments in block 208, the processor may request the digital certificate outside of the conventional procedures of accessing a website to establish a current session with the website. For example, the request for the digital certificate may not initiate an active session between the wireless communication device and a server associated with the website. Instead, the website server may just respond to the request by sending the digital certificate and not initiate any additional procedures to establish communications between the wireless communication device and the website server. In some embodiments in block 208, the processor may obtain the digital certificate using conventional procedures for establishing a session with the website, but terminate the session and not render the website content once the digital certificate has been received.

In block 210, the processor may store the received digital certificates for each predicted website. For example, for each digital certificate that the wireless communication device receives in response to the request for a digital certificate, the processor may store information associated with the digital certificate in memory of the wireless communication device. In some embodiments, the processor may store the entire digital certificate. In some embodiments, the processor may only store the digital signature associated with the digital certificate. In some embodiments, the processor may store the information associated with the digital certificate (e.g., the digital signature) in any memory of the wireless communication device. In some embodiments, the processor may store the information associated with the digital certificate in a memory within a secure area or trust zone of the wireless communication device. In some embodiments, the processor may encrypt the information associated with the digital certificate and store the encrypted information in memory. Securing the stored digital certificate information may hinder or prevent attempts to defeat the various embodiments.

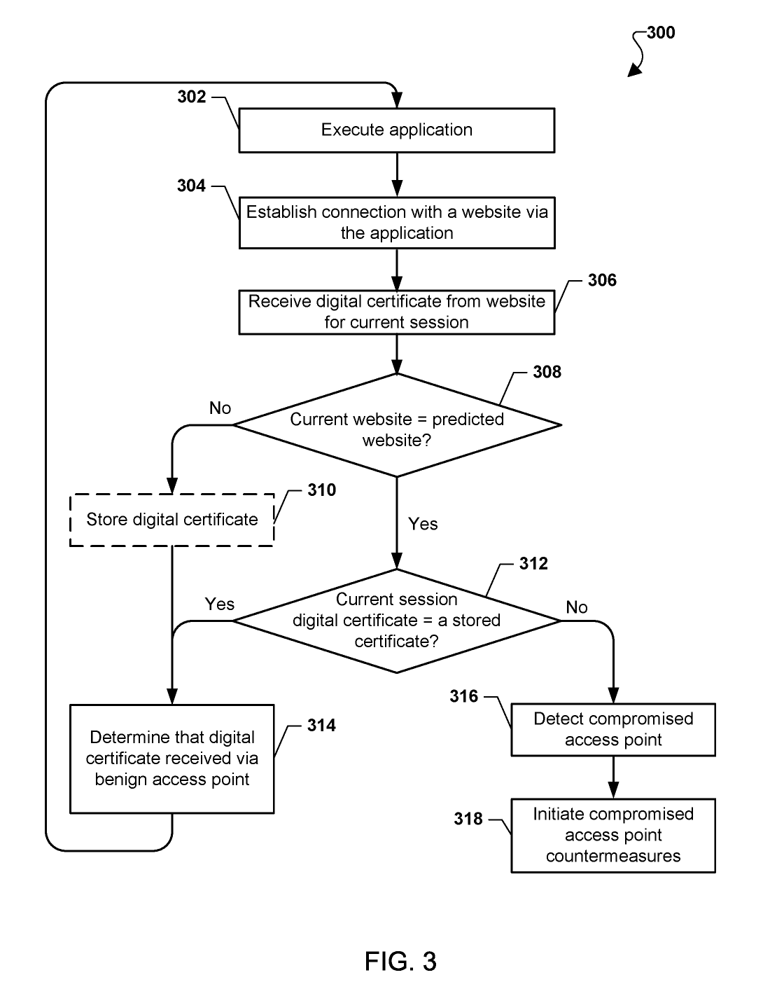

FIG. 3 is a process flow diagram illustrating a method 300 of determining whether a compromised access point is present in a network according to various embodiments. With reference to FIGS. 1-3, the method 300 may be implemented by one or more processors of a wireless communication device (e.g., 114, 116, 118).

In block 302, a processor of the wireless communication device may execute an application, such as a web browser or an application that requires access to a server. For example, the processor may launch an application in response to a user input may be received by the processor indicating that an application is to be launched or executed.

In block 304, the processor may establish a connection with a website via the application. For example, the processor may access a website server associated with the website via the application using a wireless communication link established with a wireless access point. If a wireless communication link is not already established, the processor may cause the wireless communication device may establish a link with an access point using conventional protocols. Such protocols conventionally involve monitoring for available access points by receiving availability advertisement messages, selecting one of the access points (which may involve the user selecting an access point from a list of available access points), and then performing “handshake” communication exchanges to negotiate the communication link.

In some embodiments, the processor may automatically initiate the process of establishing a connection with a website server associated with the application in response to receiving an input to execute the application by the wireless communication device. Alternatively, the processor may wait until an input associated with establishing a connection with a website server is received within the executed application.

In block 306, the processor may receive a digital certificate from the website for the current session. For example, after the processor has established communications with the website via the website server 102, the website server 102 may transmit a digital certificate associated with the website for the current session between the wireless communication device and the website server 102.

In determination block 308, the processor may determine whether the current website accessed in block 304 is the same as any website for which digital certificate information has been stored in memory of the wireless communication device. In some embodiments, the processor may determine whether the accessed website matches one of the previously predicted websites accessed in the method 200 as described with reference to FIG. 2. In some embodiments, the processor may compare information associated with the accessed website (e.g., the universal routing locator (URL)) to information stored in memory associated with stored digital certificate information. In some embodiments, the processor may compare information associated with the accessed website (e.g., the universal routing locator (URL)) to a data table of previously accessed websites stored in memory.

In response to determining that the website accessed during the current session is not the same as any of the websites for which digital certificate information has been stored in memory (i.e., determination block 308=“No”), the processor may optionally store the digital certificate in block 310, and proceed as if the digital certificate was received via a benign access point in block 314. In some embodiments, the processor may assume that the communication path is uncompromised the first time the wireless communication device and automatically store the digital certificate received during the current session. Alternatively, the processor may determine whether the digital certificate is a genuine digital certificate through other various techniques. For example, the processor may contact the website server via a second communication interface and then compare the digital certificate received during the current session with the digital certificate received over the second communication interface.

In response to determining that the website accessed during the current session is the same as any of the websites for which digital certificate information has been stored in memory (i.e., determination block 308=“Yes”), the processor may obtain the stored digital certificate information from memory and determine whether the digital certificate (or certificate signature) received during the current session matches the stored certificate information in determination block 312. For example, the processor may determine whether a hash or signature of the digital certificate received during the current session matches a digital signature of the certificate associated with a predicted website that was previously stored in memory. In some embodiments, the comparison of the digital certificate received during the current session to the stored digital certificate associated with the website may be performed by a secure processor within the secure area or trusted zone of the wireless communication device.

In response to determining that the digital certificate received during the current session matches a stored digital certificate associated with the website (i.e., determination block 312=“Yes”), the processor may determine that the digital certificate received during the current session with the website was received via a benign access point in block 314, and permit communications to proceed via the established wireless communication link.

In response to determining that the digital certificate received during the current session does not match a stored digital certificate associated with the website (i.e., determination block 312=“No”), the processor may determine that a compromised access point is present in block 316, and initiate appropriate compromised access point countermeasures in block 318.

In some embodiments, the compromised access point countermeasures initiated in block 318 may include one or more of the following countermeasures: providing a notification to the user that a rogue access point has been detected, shutting down or modifying the communication connection between the wireless communication device and the current access point, transmitting an indication to the shared server 106 that a digital certificate for the website has been identified as a fraudulent digital certificate, and/or uploading the fraudulent digital certificate to the shared server 106 where the shared server may perform additional analysis on the fraudulent digital certificate to determine a source of the fraudulent digital certificate, whether the digital signature from the CA has been compromised, etc.

The operations of the method 300 may be performed once at the start of a wireless communication session with a wireless access point, periodically during a session with a wireless access point, or each time that a new website is accessed in block 302.

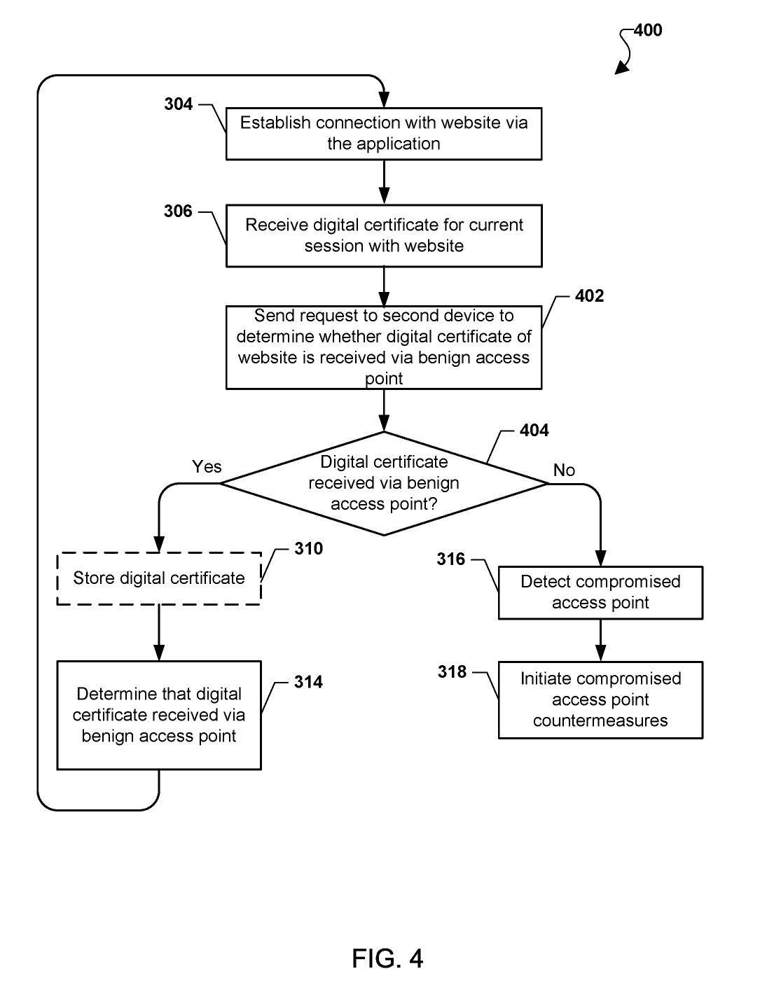

FIG. 4 is a process flow diagram illustrating a method 400 of determining whether a compromised access point is present in a network according to various embodiments. With reference to FIGS. 1-4, the method 400 may be implemented by one or more processors of a wireless communication device (e.g., 114, 116, 118). The method 400 operations that may be performed by the processor of the wireless communication device in blocks 304, 306, 310, 314, 316, and 317 of the method 300 as described.

In block 304, a processor of the wireless communication device may access a website, and receive a digital certificate in block 306 as described.

In block 402, the processor may send a request to a second device to determine whether a digital certificate of the website accessed by the processor in block 304 was received via a benign access point. In some embodiments, the second device may be a third party server (e.g., 106) and/or another wireless communication device (e.g., 114, 116, 118). The request to determine whether the digital certificate of the website is received via a benign access point may include the digital certificate received for the current session with the website.

In determination block 404, the processor may determine whether the digital certificate received during the current session with the website has been received via a benign access point. In some embodiments, this determination may be made based on an indication received from the third party server and/or the second wireless communication device. For example, the third party server and/or the second wireless communication device may perform the comparison of the digital certificate received by the wireless communication device during the current session with a digital certificate received at the third party server and/or the second wireless communication device, respectively. In some embodiments, this determination may be made by the processor comparing the information received from the third party server and/or the second communication device with the digital certificate received by the wireless communication device during the current session with the website.

When the second device is a second wireless communication device, the second wireless communication device may have accessed the website from a different geographic location than (e.g., beyond the range of WiFi communications of) the wireless communication device. Because the wireless communication device and the second wireless communication device are in different geographic locations, it is likely that the access point at which the wireless communication device accesses the network will be different from the access point in which the second wireless communication device accesses the network. Thus, if the digital certificate for the website received by the wireless communication device and the digital certificate for the website received at the second wireless communication device does not match, the wireless communication device and/or the second wireless communication device may determine that a compromised access point is present in one network or the other.

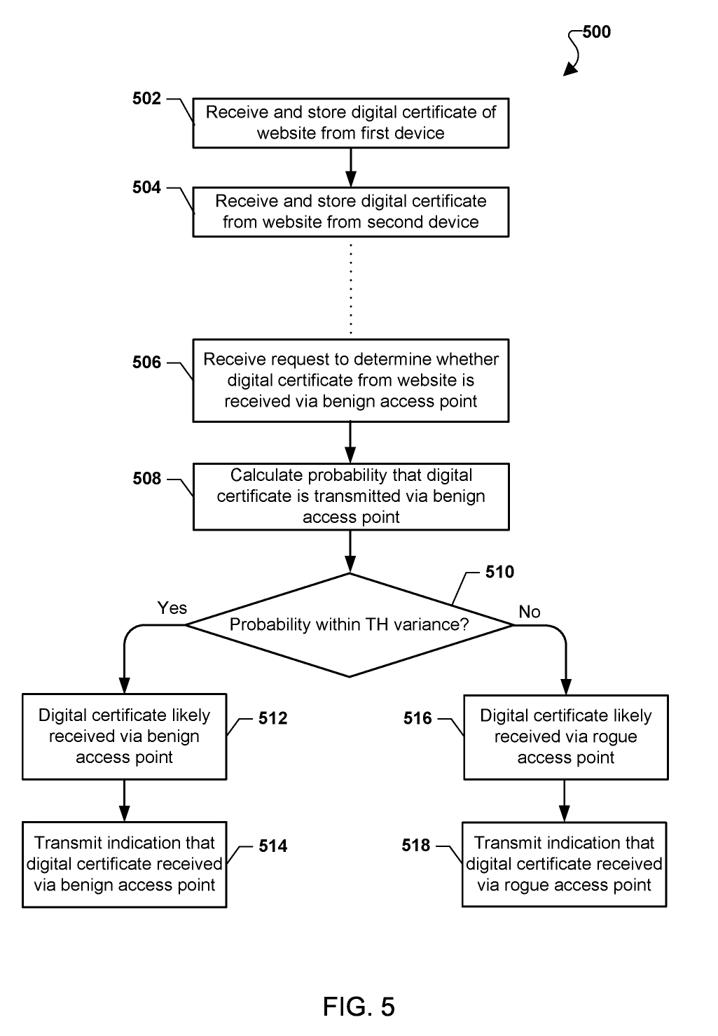

FIG. 5 illustrates a process flow diagram illustrating a method 500 of determining whether a compromised access point is present in a network according to various embodiments. With reference to FIGS. 1-5, the method 500 may be implemented by one or more processors of a third party server (e.g., 106).

In block 502, the third party server may receive and store a digital certificate from a first device. For example, the third party server may receive and store a digital certificate from a first wireless communication device (e.g., 114, 116, 118). The digital certificate may be from a current session between the first wireless communication device and a website and/or the most recent session between the first wireless communication device and the website. The third party server may store the received digital certificate such that an identifier associated with the website is mapped to the digital certificate. In some embodiments, the first wireless communication device may send a digital certificate received from the website during a single session or the first wireless communication device may periodically send a digital certificate received from the website during each session or after a predetermined increment of sessions between the first wireless device and the website.

In block 504, the third party server may receive and store a digital certificate from a second device. For example, the third party server may receive and store a digital certificate from a second wireless communication device (e.g., 114, 116, 118). The digital certificate may be from a current session between the second wireless communication device and a website and/or the most recent session between the second wireless communication device and the website. The third party server may store the received digital certificate such that an identifier associated with the website is mapped to the digital certificate. In some embodiments, the second wireless communication device may send a digital certificate received from the website during a single session or the second wireless communication device may periodically send a digital certificate received from the website during each session or after a predetermined increment of sessions between the second wireless device and the website.

In some embodiments, the third party server may store all digital certificates received for the same website a plurality of times. Alternatively, the third party server may overwrite or discard a digital certificate after a predetermined amount of time or after a predetermined number of the same digital certificates are stored in the third party server. In some embodiments, in response to determining that the digital certificates received from the first wireless communication device and/or the second wireless communication device is a genuine digital certificate, the third party server may prevent the stored digital certificate for the website from being over written or discarded. In addition, the third party server may no longer store any additional digital certificates of the website received from any device if the digital certificate matches the genuine digital certificate.

While FIG. 5 only illustrates receiving and storing a digital certificate of the website from a first wireless communication device and a second wireless communication device, any number of devices may transmit a digital certificate received from the website. For example, the third party server may receive a digital certificate from a plurality of wireless communication devices in order to determine whether a compromised or rogue access point is present in the network using crowdsourcing techniques.

In block 506, the third party server may receive a request to determine whether a digital certificate from a website is received via a benign access point. For example, the third party server may receive the request to determine whether the digital certificate is received via a benign access point from a wireless communication device (e.g., block 314). The request to determine whether the digital certificate from the website may include the digital certificate received by the wireless communication device (e.g., in block 306). Alternatively, the request to determine whether the digital certificate from the website may include an identification of the website without a digital certificate.

In block 508, the third party server may calculate a probability that the digital certificate is transmitted via a benign access point. For example, when the request to determine whether the digital certificate is received via a benign access point includes the digital certificate, the third party server may compare the digital certificate received from the wireless device with the plurality of digital certificates associated with the website received from the plurality of wireless devices. The greater the number of digital certificates that are the same for the same website, the higher the probability that the digital certificate received by the wireless communication device is received via a benign access point.

When the request to determine whether the digital certificate is received via a benign access point includes the identification of the website without a digital certificate, the third party server may retrieve all of the digital certificates associated with the website (e.g., using the mapping during storage) and determine a ratio of a number of digital certificates associated with the website that are the same to a number of the digital certificates associated with the website that are different. The greater the number of digital certificates that are the same for the same website, the higher the probability that the digital certificate received by the wireless communication device is received via a benign access point.

In determination block 510, the third party server may determine whether the probability is within a threshold variance.

In response to determining that the probability is within a threshold variance (i.e., determination block 510=“Yes”), the third party server may determine that the digital certificate received at the wireless device has likely been received via a benign access point in block 512. In block 514, the third party server may then transmit an indication that the digital certificate was received via a benign access point. In some embodiments, if the request to determine whether the digital certificate is received via a benign access point does not include the digital certificate, the third party server may select a digital certificate stored at the third party server that has been determined to be a genuine digital certificate associated with the website and include the digital certificate deemed to be a genuine digital certificate with the indication that the digital certificate is received via a benign access point in block 514.

In response to determining that the probability is not within a threshold variance (i.e., determination block 510=“No”), the third party server may determine that the digital certificate has likely been received via a compromised or rogue access point in block 516, and the third party server may transmit an indication that the digital certificate has been received via a rogue access point in block 518.

The processor may determine whether the digital certificate has been received via a benign access point in determination block 404 of the method 400 based on the indications transmitted in blocks 514 or 518.

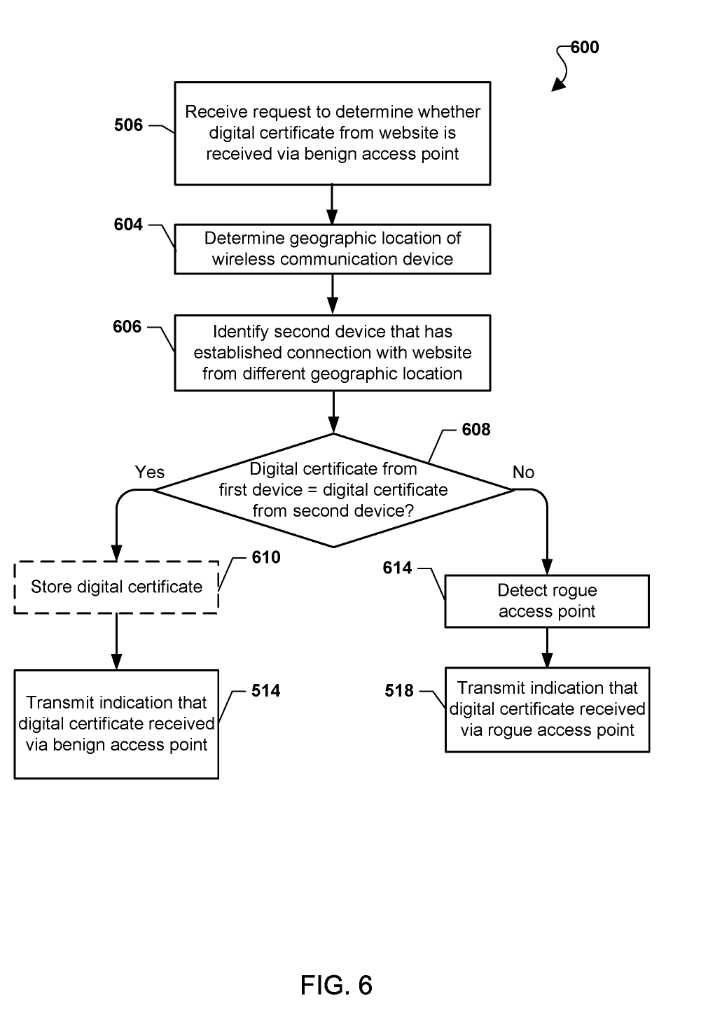

FIG. 6 illustrates a process flow diagram illustrating a method 600 of determining whether a compromised access point is present in a network according to some embodiments. With reference to 1-6, the method 600 includes example operations that may be performed by the third party server in blocks 506, 514, and 518. The method 600 may be implemented by one or more processors of the third party server (e.g., 106).

In block 604, the third party server may determine a geographic location of the device from which the request to determine whether the digital certificate from a website is received via a benign access point was received in block 506. The third party server may determine the geographic location of the device using various methods. For example, geographic location may be embedded within the request to determine whether the digital certificate is received via a benign access point. Alternatively, the third party server may contact another server associated with location information of the wireless communication device.

In block 606, the third party server may identify a second device that has established a connection with the website from a different geographic location. For example, the third party server may identify a second wireless communication device that is currently communicating with the website or a second wireless communication device that has previously communicated with the website within a predetermined amount of time. The different geographic location may be any distance away from the first wireless communication device such that it is unlikely that the first wireless communication device and the second wireless communication device are communicating with the same access points.

In decision block 608, the third party server may determine whether the digital certificate received from the first device matches the digital certificate from the second device. For example, the third party server may retrieve the digital certificate associated with the website received from the second wireless communication device (e.g., received in block 504) and compare the digital certificate received from the second wireless communication device with the digital certificate received from the first wireless communication device. In some examples, after determining that the second wireless communication device is currently in communication with the website, the third party server may request that the second wireless communication transmit the digital certificate received by the second wireless communication device during the current session and compare the digital certificate received by the second wireless communication device with the digital certificate received by the first wireless device.

In response to determining that the digital certificate received from the first device matches the digital certificate received from the second device (i.e., determination block 608=“Yes”), the third party server may optionally store the digital certificate in block 610, and transmit to the first wireless communication device in block 514 an indication that the digital certificate received by the first wireless communication device was received via a benign access point.

In response to determining that the digital certificate received from the first device does not match the digital certificate received from the second device (i.e., determination block 608=“No”), the third party server may determine that a MITM threat or attack is present at the first wireless communication device in block 614, and transmit to the first wireless communication device an indication that the digital certificate was received via a rogue access point in block 518.

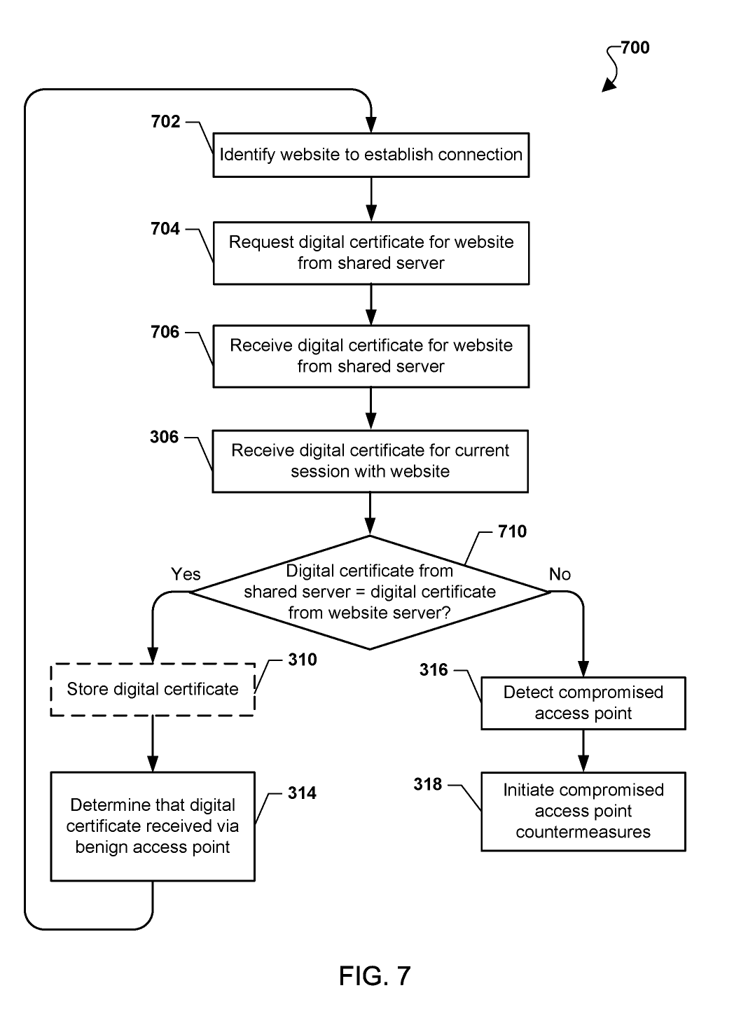

FIG. 7 is a process flow diagram illustrating a method 700 of determining whether a compromised access point is present in a network according to various embodiments. With reference to FIGS. 1-7, the method 700 includes example operations that may be performed by the processor in blocks 306, 310, 314, 316, and 318 of method 300. The method 700 may be implemented by one or more processors of a wireless communication device (e.g., 114, 116, 118).

In block 702, the processor may identify a website with which to establish a connection. For example, the processor may identify the website before and/or after executing an application to establish a connection with the website.

In block 704, the processor may request a digital certificate for a website from a shared server (e.g., 106). The shared server may determine whether a digital certificate associated with the website has been stored at the shared server and/or whether a digital certificate associated with the website has been deemed a genuine digital certificate by the shared server.

In block 706, the processor may receive the requested digital certificate for the website from the shared server. For example, if the shared server has stored a digital certificate associated with the website, the shared server may transmit the stored digital certificate to the wireless communication device. In some embodiments, the shared server may transmit a digital certificate that has been deemed to be genuine. If the shared server does not have a stored digital certificate for the requested website, the shared server may send a notification to the wireless communication device indicating that a digital certificate is not available from the shared server.

In determination block 710, the processor may determine whether the digital certificate received from the shared server matches the digital certificate received by the wireless communication device from the website server.

In response to determining that the digital certificate received from the shared server matches the digital certificate received by the wireless communication device (i.e., determination block 710=“Yes”), the processor may optionally store the digital certificate at the wireless device in block 310 and/or transmit the digital certificate to be stored at the shared server as well as determine that the digital certificate was received via a benign access point in block 314.

In response to determining that the digital certificate received from the shared server matches the digital certificate received by the wireless communication device (i.e., determination block 710=“No”), the processor may determine that compromised access point is present in the network in block 316, and initiate compromised access point countermeasures in block 318 as described.

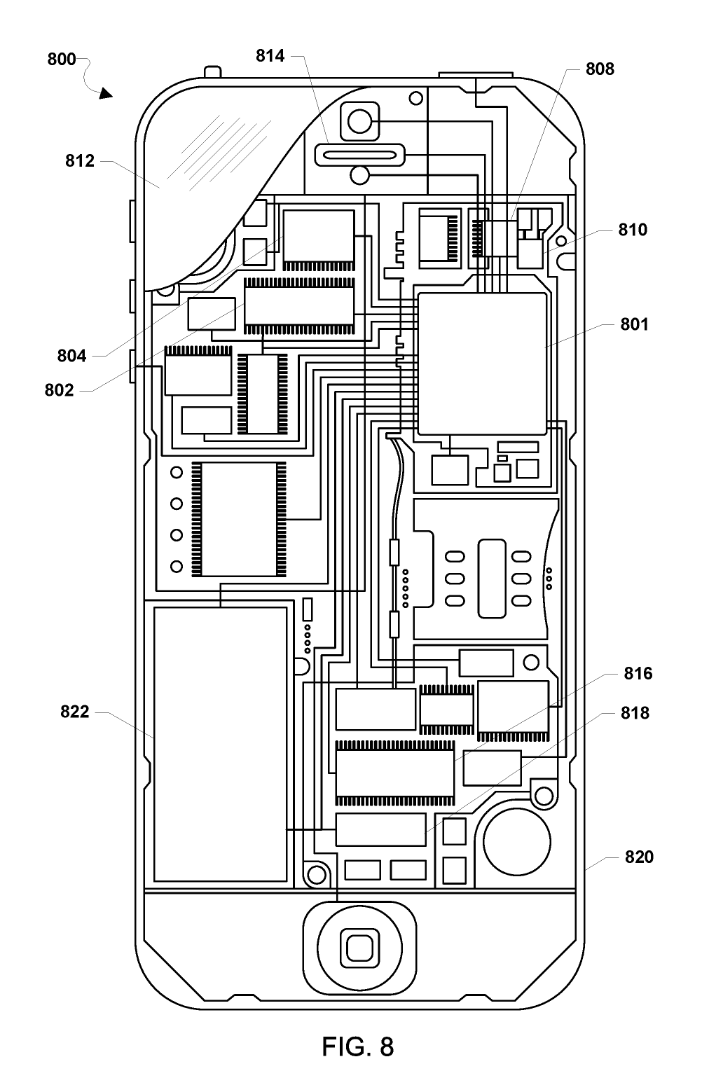

The various embodiments (including, but not limited to, embodiments discussed above with reference to FIGS. 1-7) may be implemented in any of a variety of personal devices (i.e., wireless communication devices 114, 116, 118), an example of which is illustrated in FIG. 8. For example, the personal device 800 may include a processor 801 coupled to a touch screen controller 804 and an internal memory 802. The processor 801 may be one or more multicore integrated circuits (ICs) designated for general or specific processing tasks. The internal memory 802 may be volatile or non-volatile memory, and may also be secure and/or encrypted memory, or unsecure and/or unencrypted memory, or any combination thereof. The touch screen controller 804 and the processor 801 may also be coupled to a touch screen panel 812, such as a resistive-sensing touch screen, capacitive-sensing touch screen, infrared sensing touch screen, etc.

In some embodiments, personal device 800 may include one or more radio signal transceivers 808 (e.g., Peanut®, Bluetooth®, Zigbee®, Wi-Fi, cellular, etc.) and antennae 810, for sending and receiving, coupled to each other and/or to the processor 801. The transceivers 808 and antennae 810 may be used with the above-mentioned circuitry to implement the various wireless transmission protocol stacks and interfaces. The personal device 800 may include a cellular network wireless modem chip 816 that enables communication via a cellular network and is coupled to the processor.

The personal device 800 may include a peripheral device connection interface 818 coupled to the processor 801. The peripheral device connection interface 818 may be singularly configured to accept one type of connection, or multiply configured to accept various types of physical and communication connections, common or proprietary, such as USB, FireWire, Thunderbolt, or PCIe. The peripheral device connection interface 818 may also be coupled to a similarly configured peripheral device connection port (not shown).

The personal device 800 may also include speakers 814 for providing audio outputs. The personal device 800 may also include a housing 820, constructed of a plastic, metal, or a combination of materials, for containing all or some of the components discussed herein. The personal device 800 may include a power source 822 coupled to the processor 801, such as a disposable or rechargeable battery. The rechargeable battery may also be coupled to the peripheral device connection port to receive a charging current from a source external to the personal device 800.

The personal device 800 may also include a secure area and/or a trusted execution environment. The trusted execution environment may include one or more processors and/or memory to perform secure operations that are masked from the rest of the elements of the personal device 800. For example, the trusted execution environment may include a digital rights management (DRM) client or agent such as a content decryption module (CDM) in order to perform operations in a secure environment to reduce the risk of undesired interception of secure data.

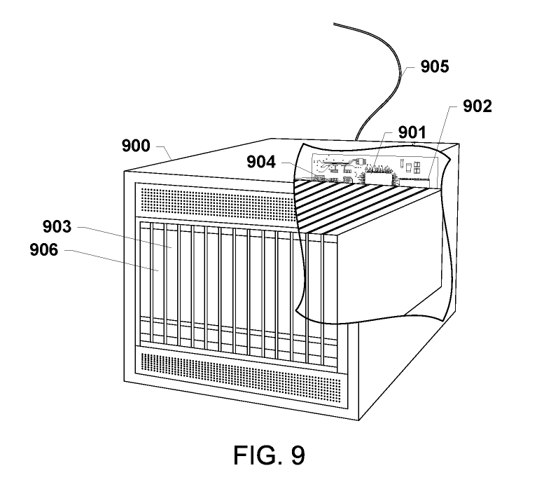

Various embodiments (including, but not limited to, embodiments described with reference to FIGS. 1, 5, and 6) may also be implemented on any of a variety of server devices, an example of which (e.g., website server 102, CA 104, shared server 106) is illustrated in FIG. 9. With reference to FIGS. 1, 5, 6, and 9, the server device 900 typically includes a processor 901 coupled to volatile memory 902, and may also include and a large capacity nonvolatile memory, such as a disk drive 904. The server device 900 may also include a floppy disc drive, compact disc (CD) or DVD disc drive 906 coupled to the processor 901. The server device 900 may also include network communication ports 903 coupled to the processor 901 for, among other things, establishing network interface connections 905 with a communication network (such as a local area network coupled to other broadcast system computers and servers, a wide area network, a content data network, the public switched telephone network, and/or a cellular data network (e.g., CDMA, TDMA, GSM, PCS, 3G, 4G, LTE, or any other type of cellular data network).

The processors 801 and 901 may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory before they are accessed and loaded into the processors 801 and 901. The processors 801 and 901 may include internal memory sufficient to store the application software instructions. In many devices, the internal memory may be a volatile or nonvolatile memory, such as flash memory, or a mixture of both. For the purposes of this description, a general reference to memory refers to memory accessible by the processors 801 and 901 including internal memory or removable memory plugged into the device and memory within the processors 801 and 901 themselves.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module and/or processor-executable instructions, which may reside on a non-transitory computer-readable or non-transitory processor-readable storage medium. Non-transitory server-readable, computer-readable or processor-readable storage media may be any storage media that may be accessed by a computer or a processor. By way of example but not limitation, such non-transitory server-readable, computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory server-readable, computer-readable and processor-readable media. Additionally, the operations of a method or algorithm may reside as one or any combination or set of codes and/or instructions on a non-transitory server-readable, processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of determining whether a compromised access point is present in a first communication network, comprising:
determining, by a processor of a first wireless communication device, whether digital certificate information received from a website server during a current session matches digital certificate information for the website server obtained via a second communication network different from the first communication network; and
determining, by the processor, that a compromised access point is present in the first communication network in response to determining that the digital certificate information received from the website server during the current session does not match the digital certificate information for the website server obtained via the second communication network.

2. The method of claim 1, further comprising:
accessing, by the processor, the website server via the second communication network, wherein the second communication network is a trusted network;
obtaining, by the processor, the digital certificate information from the website server via the second communication network; and
storing the digital certificate information for the website server in memory of the first communication network,
wherein determining whether digital certificate information received from the website server during a current session matches digital certificate information obtained for the website server via a second communication network comprises determining, by the processor, whether the digital certificate information received from the website server during the current session matches the digital certificate information for the website server stored in memory of the first wireless communication device.

3. The method of claim 1, further comprising:
transmitting a request for digital certificate information for the website server from a second wireless communication device distant from the first wireless communication device; and
receiving digital certificate information for the website server from the second wireless communication device,
wherein determining whether digital certificate information received from the website server during the current session matches digital certificate information obtained for the website server via the second communication network comprises determining, by the processor, whether the digital certificate information received from the website server during the current session matches the digital certificate information for the website server received from the second wireless communication device.

4. The method of claim 1, wherein determining whether digital certificate information received from the website server during the current session matches digital certificate information obtained for the website server via the second communication network comprises:
transmitting the digital certificate information received from the website server during the current session to a server; and
receiving an indication from the server regarding whether the transmitted digital certificate information received from the website server during the current session matches valid digital certificate information for the website server.

5. The method of claim 1, further comprising:
predicting, by the processor, websites that the first wireless communication device may access during a future session;
establishing a communication link with a trusted second communication network;
accessing, by the processor via the second communication network, website servers associated with each of the websites that the first wireless communication device may access during a future session;
obtaining, by the processor, digital certificate information from each accessed website server via the second communication network; and
storing in memory of the first communication network the digital certificate information obtained from each accessed website server,
wherein determining whether digital certificate information received from a website server during a current session matches digital certificate information obtained for the website server via a second communication network comprises determining, by the processor, whether the digital certificate information received from the website server during the current session matches digital certificate information for the website server stored in memory of the first wireless communication device.

6. The method of claim 5, wherein predicting, by the processor, websites that the first wireless communication device may access during a future session comprises:
extracting, by the processor, information regarding at least one of a website domain and a website URL; and
predicting one or more websites that the first wireless communication device will access during a future session with the one or more websites based on the extracted information regarding the at least one of the website domain and the website URL.

7. The method of claim 6, wherein extracting information regarding the at least one of the website domain and the website URL comprises at least one of:
unpacking, by the processor, binaries of one or more applications;
extracting, by the processor, information from source code of the one or more applications;
extracting, by the processor, information from one or more libraries that are used by the one or more applications;
extracting, by the processor, information from metadata of the one or more applications;
extracting, by the processor, information from a description of the one or more applications;
extracting, by the processor, information from a previous version of the one or more applications; or
extracting, by the processor, information from bytecode associated with the one or more applications.

8. The method of claim 6, wherein the stored information associated with the digital certificate received from each of the predicted websites includes the digital certificate received from each of the predicted websites.

9. The method of claim 6, wherein the stored information associated with the digital certificate received from each of the predicted websites includes only the digital signature of the digital certificate received from each of the predicted websites.

10. The method of claim 1, further comprising:
initiating a countermeasure in response to determining that a compromised access point is present in the first communication network.

11. A method of determining whether a compromised access point is present in a communication network, comprising:
receiving, by a server from a wireless communication device, digital certificate information received by the wireless communication device for a website server during a current session;
comparing, by the server, the digital certificate information received from the wireless communication device to digital certificate information associated with the website stored in memory of the server that was previously received from wireless communication devices; and
transmitting, by the server, an indication regarding whether the digital certificate information received from the wireless communication device matches valid digital certificate information for the website server stored in memory of the server.

12. The method of claim 11, further comprising:
determining, by the server, a probability that the digital certificate received from the wireless communication device was transmitted via a benign access point based on comparing the digital certificate received from the wireless communication device to digital certificate information associated with the website stored in memory of the server that was previously received from wireless communication devices; and
determining, by the server, whether the determined probability that the digital certificate received from the wireless communication device was transmitted via a benign access point is within a threshold,
wherein transmitting the indication regarding whether the digital certificate information received from the wireless communication device matches valid digital certificate information for the website server stored in memory of the server comprises transmitting, by the server, the indication that the digital certificate received by the wireless communication device was received via a rogue access point in response to determining that the calculated probability that the digital certificate received by the wireless communication device was transmitted via a benign access point is not within the threshold.

13. The method of claim 11, further comprising:
determining a location of the wireless communication device;
determining locations of wireless communication devices associated with the previously received digital certificate information; and
selecting for comparison digital certificate information associated with the website stored in memory of the server that was previously received from wireless communication devices located a threshold distant from the wireless communication device,
wherein comparing the digital certificate information received from the wireless communication device to digital certificate information associated with the website stored in memory of the server that was previously received from wireless communication devices comprises comparing, by the server, the digital certificate information received from the wireless communication device to the selected digital certificate information.

14. A first wireless communication device, comprising:
a communication interface configured to communicate with the first communication network or a second communication network;
a memory; and
a processor coupled to the communication interface and the memory, wherein the processor is configured with processor-executable instructions to perform operations comprising:
determining whether digital certificate information received from a website server during a current session matches digital certificate information for the website server obtained via the second communication network different from the first communication network; and
determining that a compromised access point is present in the first communication network in response to determining that the digital certificate information received from the website server during the current session does not match the digital certificate information for the website server obtained via the second communication network.

15. The first wireless communication device of claim 14,
wherein the processor is configured with processor-executable instructions to perform operations further comprising:
accessing the website server via the second communication network, wherein the second communication network is a trusted network;
obtaining the digital certificate information from the website server via the second communication network; and
storing the digital certificate information for the website server in memory of the first communication network, and
wherein the processor is configured with processor-executable instructions to perform operations such that determining whether digital certificate information received from the website server during the current session matches the digital certificate information obtained for the website server via the second communication network comprises determining whether the digital certificate information received from the website server during the current session matches the digital certificate information for the website server stored in the memory of the first wireless communication device.

16. The first wireless communication device of claim 14,
wherein the processor is configured with processor-executable instructions to perform operations further comprising:
transmitting a request for digital certificate information for the website server from a second wireless communication device distant from the first wireless communication device; and
receiving digital certificate information for the website server from the second wireless communication device, and
wherein the processor is configured with processor-executable instructions to perform operations such that determining whether the digital certificate information received from the website server during the current session matches digital certificate information obtained for the website server via the second communication network comprises determining whether the digital certificate information received from the website server during the current session matches the digital certificate information for the website server received from the second wireless communication device.

17. The first wireless communication device of claim 14, wherein the processor is configured with processor-executable instructions to perform operations such that determining whether the digital certificate information received from the website server during the current session matches the digital certificate information obtained for the website server via the second communication network comprises:
transmitting the digital certificate information received from the website server during the current session to a server; and
receiving an indication from the server regarding whether the transmitted digital certificate information received from the website server during the current session matches valid digital certificate information for the website server.

18. The first wireless communication device of claim 14,
wherein the processor is configured with processor-executable instructions to perform operations further comprising:
predicting websites that the first wireless communication device may access during a future session;
establishing a communication link with a trusted second communication network;
accessing, via the second communication network, website servers associated with each of the websites that the first wireless communication device may access during a future session;
obtaining digital certificate information from each accessed website server via the second communication network; and
storing in memory of the first communication network the digital certificate information obtained from each accessed website server, and
wherein the processor is configured with processor-executable instructions to perform operations such that determining whether the digital certificate information received from the website server during the current session matches digital certificate information obtained for the website server via the second communication network comprises determining whether the digital certificate information received from the website server during the current session matches digital certificate information for the website server stored in the memory of the first wireless communication device.

19. The first wireless communication device of claim 18, wherein the processor is configured with processor-executable instructions to perform operations such that predicting websites that the first wireless communication device may access during the future session comprises:
extracting information regarding at least one of a website domain and a website URL; and
predicting one or more websites that the first wireless communication device will access during a future session with the one or more websites based on the extracted information regarding the at least one of the website domain and the website URL.

20. The first wireless communication device of claim 19, wherein the processor is configured with processor-executable instructions to perform operations such that extracting information regarding the at least one of the website domain and the website URL comprises at least one of:
unpacking, by the processor, binaries of one or more applications;
extracting, by the processor, information from source code of the one or more applications;
extracting, by the processor, information from one or more libraries that are used by the one or more applications;
extracting, by the processor, information from metadata of the one or more applications;
extracting, by the processor, information from a description of the one or more applications;
extracting, by the processor, information from a previous version of the one or more applications; or
extracting, by the processor, information from bytecode associated with the one or more applications.

21. The first wireless communication device of claim 19, wherein the processor is configured with processor-executable instructions to perform operations such that the stored information associated with the digital certificate received from each of the predicted websites includes the digital certificate received from each of the predicted websites.

22. The first wireless communication device of claim 19, wherein the processor is configured with processor-executable instructions to perform operations such that the stored information associated with the digital certificate received from each of the predicted websites includes only the digital signature of the digital certificate received from each of the predicted websites.

23. The first wireless communication device of claim 14, wherein the processor is configured with processor-executable instructions to perform operations further comprising:
initiating a countermeasure in response to determining that a compromised access point is present in the first communication network.

24. A server, comprising:
a communication interface configured to communicate with a communication network;
a memory; and
a processor coupled to the communication interface and to the memory, wherein the processor is configured with processor-executable instructions to perform operations comprising:
receiving, from a wireless communication device, digital certificate information received by the wireless communication device for a website server during a current session;
comparing the digital certificate information received from the wireless communication device to digital certificate information associated with the website stored in memory of the server that was previously received from wireless communication devices; and
transmitting an indication regarding whether the digital certificate information received from the wireless communication device matches valid digital certificate information for the website server stored in memory of the server.

25. The server of claim 24,
wherein the processor is configured with processor-executable instructions to perform operations further comprising:
determining a probability that the digital certificate received from the wireless communication device was transmitted via a benign access point based on comparing the digital certificate received from the wireless communication device to digital certificate information associated with the website stored in memory of the server that was previously received from wireless communication devices; and
determining whether the determined probability that the digital certificate received from the wireless communication device was transmitted via a benign access point is within a threshold, and
wherein the processor is configured with processor-executable instructions to perform operations such that transmitting the indication regarding whether the digital certificate information received from the wireless communication device matches valid digital certificate information for the website server stored in memory of the server comprises transmitting, by the server, the indication that the digital certificate received by the wireless communication device was received via a rogue access point in response to determining that the calculated probability that the digital certificate received by the wireless communication device was transmitted via a benign access point is not within the threshold.

26. The server of claim 24,
wherein the processor is configured with processor-executable instructions to perform operations further comprising:
determining a location of the wireless communication device;
determining locations of wireless communication devices associated with the previously received digital certificate information; and
selecting for comparison digital certificate information associated with the website stored in memory of the server that was previously received from wireless communication devices located a threshold distant from the wireless communication device,
wherein the processor is configured with processor-executable instructions to perform operations such that comparing the digital certificate information received from the wireless communication device to the digital certificate information associated with the website stored in memory of the server that was previously received from wireless communication devices comprises comparing, by the server, the digital certificate information received from the wireless communication device to the selected digital certificate information.
